(19) United States
(12) Patent Application Publication
(10) Pub. No.: US 2010/0171070 A1
(43) Pub. Date: Jul. 8, 2010

(54) PROCESS AND POLYMER FOR PREVENTING Ba/Sr SCALE WITH A DETECTABLE PHOSPHORUS FUNCTIONALITY

(75) Inventors: Lidcay Herrera Taboada, Ludwigshafen (DE); Marcus Guzmann, Muhlhausen (DE); Karin Neubecker, Frankenthal (DE); Alexander Göthlich, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE Patents, Trademarks and Licenses, Ludwigshafen (DE)

(21) Appl. No.: 12/520,642

(22) PCT Filed: Dec. 17, 2007
(86) PCT No.: PCT/EP07/64018

§ 371 Date: Oct. 20, 2009

(30) Foreign Application Priority Data
Dec. 21, 2006 (EP) 06126744.9

(51) Int. Cl. C02F 5/10; C08F 22/04; C08F 20/08; C09K 8/52

(52) U.S. Cl. 252/180; 525/327.6; 525/327.4; 507/90; 507/221

(57) ABSTRACT

The present invention relates to a process for preparing a phosphorus-containing polymer, comprising the steps of
(i) copolymerizing at least
   (a) monoethylenically unsaturated dicarboxylic anhydrides having from 4 to 6 carbon atoms with
   (b) olefins of the formula CH₂═C(R¹)R² where
      R¹ is H or CH₃ and
      R² is H, CH₃, C₂H₅ or phenyl;
(ii) reacting the polymer formed in step (i) with at least one primary or secondary phosphorus-containing amine or a phosphorus-containing alcohol and
(iii) at least partly ring-opening the remaining anhydride groups.

The invention further relates to phosphorus-containing polymers obtainable from this process, and to processes for preventing Ba/Sr scale with the aid of the polymer.

The present invention relates to processes for preparing phosphorus-containing polymers and to polymers obtainable from such processes and to processes for preventing Ba/Sr scale with the aid of the polymers.

In order to reduce or to prevent the deposition of sparingly soluble alkaline earth metal salts from aqueous systems, scale inhibitors are used in industry. They are used in different technical fields, for example in boilers for steam-raising, in the distillative desalination of seawater, in the evaporative concentration of syrup, in reverse osmosis and in oil and gas extraction or transport. In the latter application, for example, sparingly soluble inorganic salts, for example calcium carbonate, calcium sulfate, barium sulfate and strontium sulfate, precipitate out of the production water and form troublesome deposits within the delivery equipment, which can even lead to stoppage of the production. The formation of such deposits is based on changes in the solubility parameters, such as temperature and pressure during the extraction or else, for example, as a result of mixing of formation water comprising alkaline earth metal ions with sulfate ion-rich seawater in the formation or within the delivery equipment. Deposits within the formation impair the permeability of the deposit and thus reduce the productivity of oil and gas.

The scale inhibitors used are, for example, polyacrylic acid, polymaleic acid or hydrolyzed water-soluble copolymers of maleic anhydride and, for example, C₂-C₁₂-olefins. In oil and gas extraction, it is possible, for example, to inject the scale inhibitor dissolved in water in an injection or production bore or directly into the delivery line by means of a probe into the lower part of the production bore. Typically polycarboxylates or oligo-/polyphosphates are used here. When the scale deposits in the deposit occur in the influx region of the production probe, they can only be prevented by a squeeze treatment with a suitable scale inhibitor. In a squeeze treatment, the dissolved scale inhibitor is introduced in excess virtually as a reservoir directly into the formation in order to be deposited on the formation rock. During the extraction, the inhibitor is detached continuously from the formation rock. The content of scale inhibitor in water, which, for example, comes out of the deposit together with oil, is checked at particular time intervals. Only when the concentration goes below a critical concentration of scale inhibitor is another squeeze treatment carried out. Moreover, it is important to determine the component composition of the production water.

U.S. Pat. No. 4,018,702 discloses the use of reaction products of polymaleic anhydride and compounds comprising amino groups. Suitable reaction products are, for example, the adducts of iminodiacetate onto polymaleic anhydride, and the addition products of diethanolamine or ethanolamine onto polymaleic anhydride. The effectiveness of such products in scale inhibition is, however, in need of improvement.

The preparation of polymaleic anhydride by free-radical polymerization of maleic anhydride in inert solvents is known, for example, from GB-A-1 024 725, GB-A-1 411 063 and U.S. Pat. No. 3,810,834.

In the process known from U.S. Pat. No. 4,818,795, maleic anhydride is polymerized in aromatic hydrocarbons at temperatures of from 60 to 200° C. in the presence of from 1 to 20% by weight, based on maleic anhydride, of peroxy esters. Polymaleic anhydrides with a low residual monomer content are obtained.

EP-A 0 264 627 and EP-B 0 276 464 disclose processes for preparing copolymers comprising maleic anhydride units. The copolymerization is effected in the presence of peroxy esters as catalysts in aromatic hydrocarbons, e.g. toluene, xylene, ethylbenzene and isopropylbenzene. The comonomers used may, for example, be vinyl esters of saturated C₁-C₄-carboxylic acids, ethylenically unsaturated C₃-C₅-carboxylic acids and compounds comprising at least two monoethylenically unsaturated double bonds. The maleic anhydride units comprise polymers which are prepared by free-radical polymerization in aromatic solvents and comprise considerable amounts of solvents in bound form.

EP-B 0 009 171 discloses the preparation of polymaleic anhydride by polymerizing maleic anhydride in acetic anhydride with hydrogen peroxide as the catalyst.

WO-A 97/16464 describes the use of polycarboxylic partial amides as scale inhibitors.

EP-B 479 465 describes the inhibition of the deposition of barium scale by addition of phosphonates.

Mixtures of polymeric scale inhibitors with phosphonates are described in U.S. Pat. No. 4,874,535.

In order to maintain the action of the scale inhibitor permanently, it is necessary to monitor its presence and concentration either continuously or discontinuously.

This can be done firstly by determining the concentration of the inhibitor itself with the aid of common detection and analysis methods.

In addition, however, scale inhibitors which have a “probe” have also been developed, in which case their concentration determination can be concluded indirectly from the content of the scale inhibitor.

WO-A 2005/000747 proposes, for example, polymeric scale inhibitors in whose formation an unsaturated monomer is used, which has, as a substituent, an aromatic ring which enables corresponding detection.

Analogously, U.S. Pat. No. 6,995,120 proposes the use of ethylenically unsaturated vinyl sulfonate monomers.

Finally, WO-A 2005/001241 describes polymeric scale inhibitors in whose preparation vinylphosphonic acids can be used as monomers.

As has already been detailed, scale inhibitors find use for a wide variety of different systems. However, a common factor for all is that the deposition especially of sparingly soluble alkaline earth metal salts is to be prevented. In this connection, the term “scale” is frequently also used. In this context, the precipitation especially of sulfates and/or carbonates of the alkaline earth metals barium and strontium (Ba/Sr scale) is problematic.

In spite of numerous scale inhibitors which are known in the prior art and which have a “probe” which eases determination of their content, there is still a need for improved scale inhibitors and processes for their preparation, which can serve to prevent Ba/Sr scale.

It is thus an object of the present invention to provide compounds with improved properties and improved preparation processes for the prevention of Ba/Sr scale, which are detectable easily with the aid of a “probe”.

This object is achieved by a process for preparing a phosphorus-containing polymer, comprising the steps of
(i) copolymerizing at least
   (a) monoethylenically unsaturated dicarboxylic anhydrides having from 4 to 6 carbon atoms with
   (b) olefins of the formula CH₂═C(R¹)R² where
      R¹ is H or CH₃ and
      R² is H, CH₃, C₂H₅ or phenyl;
(ii) reacting the polymer formed in step (i) with at least one primary or secondary phosphorus-containing amine or a phosphorus-containing alcohol and
(iii) at least partly ring-opening the remaining anhydride groups.

This is because it has been found that the above-described preparation process leads to phosphorus-containing polymers which firstly have good properties for prevention of Ba/Sr scale and secondly can be detected easily owing to the presence of a phosphorus-containing group. In this context, it was especially surprising that the properties as a scale inhibitor of the polymer obtained in step (i), which is already known to have good properties for prevention of Ba/Sr scale, are not adversely affected by the reaction of the phosphorus-containing amine or alcohol. Such properties of the polymer from step (i) are, for example described in GB-A 2 172 278 and in the international application with the application number PCT/EP2006/063340.

In addition, the object is achieved by a phosphorus-containing polymer obtainable from the above-described process.

In step (i), the copolymerization of at least components (a) and (b) is effected. It is equally possible to use only components (a) and (b).

Component (a) may consist of one of the anhydrides or a plurality of different anhydrides. Component (b) may likewise consist of one of the olefins or a plurality of olefins.

The polymer formed in step (i) can also be prepared with addition of further monomers. It is thus possible to use crosslinkers which have at least two monoethylenically unsaturated double bonds in the molecule. The proportion of such crosslinkers may be in the range from 0.001 to 5% by weight, based on the sum of the weights of monomers (a) and (b).

The molar ratio of monomer (a) to monomer (b) is preferably in the range from 20:1 to 1:5. The ratio is more preferably in the range from 10:1 to 1:3. The ratio is most preferably 3:2.

Process for preparing polymers in step (i) of the process according to the invention are known. They typically take place in inert organic solvents in which the polymers formed are soluble and are frequently present therein, on completion of the polymerization, in amounts of more than 10% by weight. The reaction takes place typically in the presence of free radical-forming polymerization initiators. In addition, chain transferors may be used.

In addition, protective colloids may be used. They may be present, for example, in the range from 0.05 to 4% by weight, based on the monomers used in the polymerization. When the protective colloids used are polymers of C₁- to C₁₂-alkyl vinyl ethers, they preferably have K values of from 10 to 200 (measured according to H. Fikentscher in cyclohexanone at a polymerization concentration of 1% by weight and 25° C.).

Useful monomers (a) include monoethylenically unsaturated dicarboxylic acids having from 4 to 6 carbon atoms. For example, these are maleic anhydride, itaconic anhydride, citraconic anhydride, methylenemaleic anhydride and mixtures of the compounds mentioned.

Preference is given to using maleic anhydride (MA) as the monomer of component (a).

Monomers of component (b) are olefins of the formula H₂C═C(R¹)R² in which R¹═H, CH₃, and R²═H, CH₃, C₂H₅ or phenyl.

Preferred compounds of this type are ethylene, propylene, isobutylene, butene-1, styrene and 2-phenylpropene.

From this group of monomers, preference is given to using isobutene as monomer (b).

As detailed above, as well as monomers (a) and (b), further monomers may be involved in the copolymerization in step (i) of the process according to the invention. Mention should be made here especially of crosslinkers which have at least two nonconjugated monoethylenically unsaturated compounds in the molecule.

Suitable crosslinkers of this type are, for example, diacrylates or dimethylacrylates of at least divalent saturated alcohols, for example ethylene glycol diacrylate, ethylene glycol dimethacrylate, 1,2-propylene glycol diacrylate, 1,2-propylene glycol dimethacrylate, butanediol 1,4-diacrylate, butanediol 1,4-dimethacrylate, hexanediol diacrylate, hexanediol dimethacrylate, neopentyl glycol diacrylate, neopentyl glycol dimethacrylate, 3-methylpentanediol diacrylate and 3-methylpentanediol dimethacrylate. It is also possible to use the acrylic and methacrylic esters of alcohols having more than two OH groups as crosslinkers. These are, for example, trimethylolpropane triacrylate or trimethylolpropane trimethacrylate.

A further class of crosslinkers is that of diacrylates or dimethacrylates of polyethylene glycols or polypropylene glycols having molecular weights of in each case from 200 to 9000. Polyethylene glycols or polypropylene glycols which can be used for the preparation of the diacrylates or dimethacrylates preferably have a molecular weight of in each case from 400 to 2000. Apart from the homopolymers of ethylene oxide or propylene oxide, it is also possible to use block copolymers of ethylene oxide and propylene oxide or copolymers of ethylene oxide and propylene oxide in which the ethylene oxide and propylene oxide units are present in random distribution. The oligomers of ethylene oxide or propylene oxide are also suitable for the preparation of the crosslinkers, for example diethylene glycol diacrylate, diethylene glycol dimethacrylate, triethylene glycol diacrylate, triethylene glycol dimethacrylate, tetraethylene glycol diacrylate and/or tetraethylene glycol dimethacrylate.

Suitable crosslinkers are also vinyl esters of ethylenically unsaturated C₃- to C₆-carboxylic acids, for example vinyl acrylate, vinyl methacrylate or vinyl itaconate. Suitable crosslinkers are also vinyl esters with saturated carboxylic acids comprising at least two carboxyl groups, and also di- and polyvinyl ethers of at least dihydric alcohols, for example divinyl adipate, butanediol divinyl ether and trimethylolpropane trivinyl ether. Further crosslinkers are allyl esters of ethylenically unsaturated carboxylic acids, for example allyl acrylate and allyl methacrylate, allyl ethers of polyhydric alcohols.

Also suitable as crosslinkers are methylenebisacrylamide, methylenebismethacrylamide, divinylethyleneurea, divinylpropyleneurea, divinylbenzene, divinyldioxane, tetraallylsilane and tetravinylsilane.

The crosslinkers may be used in the copolymerization either alone or in the form of mixtures. If crosslinkers are also used, they are used preferably in an amount of from 0.2 to 0.5% by weight, based on the monomer mixture of (a) and (b).

The copolymers are soluble in organic solvents and, on completion of the polymerization, are typically present in an amount of at least 10% by weight.

The organic solvents used are typically inert organic solvents, as known in the prior art for the preparation of the abovementioned compounds.

Preference is given to using aromatic solvents such as benzene, toluene, o-xylene, m-xylene, p-xylene, ethylbenzene, cumene and mixtures of the aromatic solvents mentioned in a suitable ratio. In practice, the mixtures of aromatics customary in industry have particular significance, for example mixtures of the xylenes.

The monomers (a) and (b) and if appropriate further monomers are copolymerized in step (i) of the process according to the invention typically in the presence of free radical-forming polymerization initiators. Initiators suitable for the preparation are known, for example, from EP-B 0 106 991. They are used typically in amounts of from 0.01 to 20% by weight, preferably from 0.05 to 10% by weight, based on the monomers used in the polymerization. The copolymerization can also be performed by the action of ultraviolet radiation, if appropriate in the presence of UV initiators. Such initiators are, for example, compounds such as benzoin and benzoin ethers, α-methylbenzoin or α-phenylbenzoin. It is also possible to use so-called triplet sensitizers such as benzyl diketals. The UV radiation sources used are, for example, in addition to high-energy UV lamps such as carbon arc lamps, mercury vapor lamps or xenon lamps, also low-UV light sources such as luminophore tubes with high blue content.

Should the copolymers have a low K value, the copolymerization is appropriately performed in the presence of regulators. Suitable regulators are, for example, mercapto compounds such as mercaptoethanol, mercaptopropanol, mercaptobutanol, mercaptoacetic acid, mercaptopropionic acid, butyl mercaptan and dodecyl mercaptan. Suitable regulators are also allyl compounds such as allyl alcohol, aldehydes such as formaldehyde, acetaldehyde, propionaldehyde, n-butyraldehyde and isobutyraldehyde, formic acid, ammonium formate, propionic acid and butenols. If the copolymerization is performed in the presence of regulators, generally from 0.05 to 20% by weight are required for this purpose, based on the monomers used in the polymerization.

Suitable protective colloids are polyalkyl vinyl ethers having from 1 to 12 carbon atoms in the alkyl radical. The K values of the polyalkyl vinyl ethers are typically from 10 to 200, preferably from 20 to 100 (measured in 1% solution in cyclohexanone at 25° C.).

Suitable polyalkyl vinyl ethers are, for example, polymethyl vinyl ether, polyethyl vinyl ether, polypropyl vinyl ether, polyisopropyl vinyl ether, polybutyl vinyl ether, polyisobutyl vinyl ether and polyhydroxybutyl vinyl ether, and also mixtures of the polyalkyl vinyl ethers mentioned. Preference is given to using polyethyl vinyl ether as the protective colloid. The amount of protective colloid added is typically from 0.05 to 4% by weight, preferably from 0.1 to 2% by weight, based on the monomers used in each case in the polymerization.

The polymerization in step (i) of the process according to the invention is effected typically at temperatures of from 30° C. to 200° C., preferably from 50° C. to 160° C. Low polymerization temperatures are employed to prepare lightly crosslinked and high molecular weight copolymers, while high polymerization temperatures are selected to prepare polymers with low K values. The molecular weights also depend on the amount of the polymerization initiators used in each case. The copolymerization can be performed at standard pressure, under reduced pressure and—especially in the case of copolymerization of ethylene, propylene and isobutene—under elevated pressure, for example at pressures of from 1 to 200 bar.

In order to prepare lightly crosslinked and particularly high molecular weight copolymers, the organic solvent, any protective colloid present and the monomers are initially charged in the reactor and polymerized in a nitrogen stream at the desired polymerization temperature by slow continuous addition of the initiator in portions. The initiator is metered in such a way that the heat of reaction formed can be removed in a controlled manner. The polymer may be obtained as a suspension in the form of fine particles and be isolated as a powder by drying or remain in solution (precipitation or solution polymerization).

In order to prepare medium molecular weight and low molecular weight copolymers, the solvent, any protective colloid present and the ethylenically unsaturated dicarboxylic anhydride are initially charged in the reactor and heated to the desired polymerization temperature in a nitrogen stream, and then the olefin is metered in continuously or in portions over a prolonged period, preferably within from 2 to 8 hours. After the end of the copolymerization, the polymer can be separated from the organic solvent.

The polymer obtained from step (i) of the process according to the invention for preparing a phosphorus-containing polymer is reacted in step (ii) with a primary or secondary phosphorus-containing amine or a phosphorus-containing alcohol.

In this reaction, the anhydride functionalities are converted at least partly to amides or esters. This can affect both dicarboxylic acid functionalities or only one of them. In the case of use of a primary amine, an imide bond is likewise possible.

It is not necessary to convert all of the anhydride functionalities.

Instead, it is preferred that the amount of amine or alcohol is from 0.01 to 30% by weight, based on the polymer formed in step (i). More preferably, the amount is from 0.1 to 15% by weight, more preferably from 0.5 to 8% by weight, more preferably from 1 to 5% by weight and especially from 2 to 3% by weight.

The primary or secondary phosphorus-containing amine or phosphorus-containing alcohol is preferably a compound of the formula XR(R′Y)ₙ, where X is OH or NHR³; R is a spacer molecule; R′ is a covalent bond or a spacer molecule; Y is a phosphoric acid radical, a phosphonic acid radical, a phosphorous acid radical or a corresponding salt or ester, R³ is H, CH₃, C₂H₅ or (R′Y)ₙ and n is 1, 2, 3 or 4.

When radicals occur more than once, they may be the same or different. A suitable salt Y is especially an alkali metal salt such as a sodium or potassium salt, or an ammonium salt such as an unsubstituted ammonium salt, ethanolammonium salt, triethanolammonium salt or a morpholinium salt.

Suitable esters are especially C₁- to C₆-alkyl esters, especially methyl, ethyl, n-propyl or i-propyl esters. Y is preferably a phosphate salt or a phosphonate salt. n is more preferably 1 or 2. In addition, X is preferably NH₂.

The spacer molecule is preferably a straight-chain or branched C₁- to C₂₀-alkylene, preferably C₁- to C₆-alkylene, more preferably C₁- to C₄-alkylene group, which may also be unsubstituted or may have one or more substituents which are each independently selected from the group consisting of OCH₃, Cl, Br, NO₂, CH═CH₂ or C(CH₃)═CH₂, and where the alkylene group may be interrupted by one or more groups or atoms selected from O, S, N(R³), N(R³)C(O) and C(O)N(R³).

Particularly preferred compounds are those of the formula X—(CHR⁴)ₘ—X¹—R′Y where X is OH or NH₂, R⁴ is H or CH₃, X¹ is a bond, NH or N(R′Y), R′ is a bond or (CH₂)ₘ, m is 1 or 2 and Y is a phosphonic acid or phosphoric acid radical or a salt thereof.

Particularly suitable compounds are 2-aminoethylphosphonic acid, 2-aminoethyl dihydrogenphosphate, DL-1-aminoethylphosphonic acid and 2-hydroxyethyl-N,N-bismethylenephosphonic acid. Preference is given to effecting the reaction with the phosphorus-containing amine or alcohol at the same temperature as the polymerization in step (i).

Typically, the reaction can be performed for from 1 to 4 hours. A workup can be effected by removing the solvent, for example by means of steam distillation.

Finally, in step (iii), an at least partial ring-opening of the remaining anhydride groups of the now phosphorus-containing polymer is effected. In this step, some of the ester or amide or imide bonds formed can be cleaved. A check can be effected easily by common detection methods such as NMR or IR. Owing to the higher stability of the amides, amines are preferred in the reaction of the polymer from step (i).

The phosphorus-containing polymer is thus not used as such, but rather there is at least partial ring-opening of the unconverted anhydride groups. It is also possible for any imide groups formed to be cleaved. The ring-opening of the remaining anhydride groups preferably takes place completely. This can be done in a simple manner by reaction with an acid (to form carboxylic acid functions) or a base with salt formation. Preference is given here to polymer salt formation.

The acids used may, for example, be salts, sulfuric acid, phosphoric acid, alkanesulfonic acids.

The phosphorus-containing polymer in the form of its salt is particularly advantageous because such a polymer salt in aqueous solution does not cause any precipitation even in the case of dilution with, for example, seawater.

Preference is given to effecting the ring-opening in an aqueous solution comprising a base, which can then be used as such or, if appropriate, after dilution. Suitable bases are sodium hydroxide solution, potassium hydroxide solution, ammonia or amines, such as ethanolamine, diethanolamine, triethanolamine or else morpholine.

Preference is given to converting the phosphorus-containing copolymer directly from the aqueous polymer suspension, after conversion of the alcohol or amine, to an aqueous salt solution. In this case, water is first added to the copolymer suspension and then the solvent is distilled off, if appropriate as an azeotropic mixture with water, by introducing steam.

Once the inert organic solvent has been distilled off, the anhydride groups are opened at least partly, as has been detailed above. This can be converted to the polymer salt, for example, by adding bases, for example sodium hydroxide solution, potassium hydroxide solution, ammonia or amines such as ethanolamine, diethanolamine, triethanolamine or else morpholine, or be converted to the acid form by adding acid.

The process according to the invention for preparing a phosphorus-containing polymer is typically performed in stirred tanks which are equipped with an anchor stirrer, blade stirrer, impeller stirrer or multistage momentum countercurrent stirrer. Particularly suitable apparatus is that which, after the reaction, permits the direct isolation of the solid, for example paddle dryers. The resulting polymer suspensions can be dried directly in evaporators, for example belt dryers, paddle dryers, spray dryers or fluidized bed dryers. However, it is also possible to remove the majority of the inert solvent by filtration or centrifugation and, if appropriate, to remove residues of initiators, monomers and protective colloids—where present—by washing with fresh solvent, and only then to dry the copolymers. In such a case too, the at least partial opening of the anhydride groups is effected subsequently.

Preference is given to phosphorus-containing polymer salts which have K values of from 5 to 40 (measured according to H. Fikentscher in 1% by weight aqueous solution of the copolymers at pH 8 and 25° C.).

The preferably water-soluble phosphorus-containing copolymers typically have K values of from 8 to 300, preferably from 10 to 250. The K values of the copolymers may be determined according to H. Fikentscher, Cellulose-Chemie, Volume 3, 48-64 and 71-74 (1932) in aqueous solution at a pH of 8, a temperature of 25° C. and a polymer concentration of the sodium salt of the copolymers of 1% by weight.

The phosphorus-containing polymer preferably has, before opening of the anhydride functions, a mean molar mass which is in the range from 200 to 10 000. M_{W} is preferably in the range from 1000 to 7000, more preferably in the range from 2000 to 6000, especially preferably in the range from 3000 to 5000.

The present invention further provides a phosphorus-containing polymer obtainable from the process according to the invention for its preparation.

The inventive phosphorus-containing polymer can be used to prevent Ba/Sr scale.

The present invention therefore further provides a process for preventing Ba/Sr scale, comprising the step of
(a) adding a phosphorus-containing polymer to a liquid which is suitable for depositing Ba/Sr scale in a liquid environment.

In this case, the phosphorus-containing polymer is preferably added as a salt in an aqueous solution.

The process according to the invention serves to prevent Ba/Sr scale (inhibition of the precipitation of Ba/Sr scale). Ba/Sr scale is caused by at least one of the salts BaSO₄, SrSO₄, BaCO₃ and SrCO₃. In addition, further sparingly soluble salts of the alkaline earth metals and if appropriate oxides of other metals may be present in the liquid.

Such salts are, for example, calcium carbonate, calcium sulfate, calcium silicates, magnesium silicates, magnesium hydroxide and magnesium carbonate, and also, for example, iron(III) oxide.

In the context of the present invention, there is already prevention or inhibition of Ba/Sr scale when the formation of a precipitate of at least one of the salts BaSO₄, SrSO₂, BaCO₃, SrCO₃ is at least partly prevented or delayed.

The polymer used in the process according to the invention can reduce or prevent the formation of crystals of the abovementioned salts in a liquid, especially in water-bearing systems. Additionally or alternatively, they may also influence the formation of precipitates of such salts. In this way, liquid environment, for example a tank, a pipeline a pressure vessel, but also a rock formation or production and/or injection boreholes for mineral oil or natural gas extraction and storage tanks or apparatus in oil production, is kept free from precipitates. Moreover, this allows the corrosion tendency, especially the risk of pitting corrosion, to be reduced crucially. The process according to the invention allows the lifetime of equipment or plants to be increased. The shutdown times and costs for cleaning plant parts or equipment can be reduced considerably by the process according to the invention.

The process is therefore particularly suitable when the liquid is one which comprises water and/or mineral oil and/or natural gas. In particular, the liquid is water.

More preferably, the liquid environment, for example a tank, a pipeline, a pressure vessel, a rock formation or a production and/or injection borehole, serves for mineral oil or natural gas extraction, for storage, heating or cooling, transport, delivery of the liquid or as a deposit of the liquid.

The liquid present in the liquid environment in question comprises the polymer of the process according to the invention typically in a substoichiometric amount. In this context, concentrations of up to about 1000 ppm are customary. Typically, it has been found that particularly good results can be achieved when the polymer salt is added such that it has a concentration in the liquid of at most 250 ppm, more preferably at most 100 ppm, even more preferably at most 50 ppm, especially at most 25 ppm, based on the weight of the polymer and of the liquid. A minimum concentration here is typically 0.01 ppm, preferably 0.1 ppm, more preferably 0.5 ppm, even more preferably 1 ppm, especially 5 ppm, based on the weight of the polymer and of the liquid.

The process according to the invention for preventing Ba/Sr scale is preferably performed at liquid temperatures below 150° C. The temperature is preferably at least room temperature, more preferably more than 50° C. Typical hydrothermal conditions give rise to a temperature of about 80° C.

The inventive polymer is therefore suitable especially as a scale inhibitor in the above-described oil and gas extraction, and also transport.

The phosphorus-containing inventive polymer may, for example, be metered in at the lower end of a borehole. For this purpose, a probe may be used. Preference is given to pressing the phosphorus-containing polymer together with the injection water into the rock formation. More preferably, the polymer is pressed into a rock formation through the production borehole (squeeze treatment).

In addition, the process according to the invention for preventing Ba/Sr scale may comprise steps which relate to determining the concentration of the phosphorus-containing polymer.

The process according to the invention for preventing Ba/Sr scale therefore preferably further comprises the steps of
(b) withdrawing a sample from the liquid environment, comprising the phosphorus-containing polymer, and
(c) determining the phosphorus content of the sample, if appropriate after derivatizing the phosphorus-containing polymer.

The derivatization may, for example, be the oxidation of the phosphorus in the phosphorus-containing polymer, and the hydrolysis can optionally be effected.

Firstly, the phosphorus content can be determined by means of inductively coupled plasma atomic emission spectrometry (ICP-AES), this content corresponding to the proportion of phosphorus-containing polymer.

In addition, for example, there exists the possibility of determining the phosphorus content with the aid of a molybdenum blue test.

The person skilled in the art is aware in principle of methods of determining the phosphorus content.

When the phosphorus is present in the form of a phosphonate, it may, as stated above, be appropriate to convert it, for example, to ortho-phosphate with the aid of the Hach persulfates/acid oxidation method. Typically, however, it is preceded by a sample pretreatment to the effect that troublesome ions are removed beforehand. In this case, especially phosphate ions have to be removed from the sample before the oxidation step.

In addition, Hack Phosver 3 powder can be added to the ortho-phosphate and the resulting color can be measured in a spectrometer, for example at a wavelength of 890 nm. The concentration of the phosphorus-containing polymer in the sample can then be determined with the aid of calibration lines. It is possible to use different standards. The end determination can be effected based on DIN 38405 Part 11.

### EXAMPLES

### Example 1

### Preparation of Inventive Phosphorus-Containing Polymers

The inventive polymers A, B and C are prepared by first preparing a polymer from maleic anhydride (MA) and isobutene (IB), which is then reacted with an amine or alcohol. The composition, the solids content and the theoretical and determined phosphorus content can be taken from the table which follows.

| | | Composition | Solids | | |
|---|---|---|---|---|---|
| | | MA/IB/A | content | % P | % P |
| Polymer | Amine/alcohol (A) | (% by wt.) | (%) | Target | Measurement |
| A | 2-Aminoethylphosphonic acid | 70.2/28/1.8 | 51.9 | 0.18 | 0.17 |
| B | 2-Hydroxyethylamino-N,N- | 60.5/24.1/15.4 | 54.9 | 0.82 | 0.84 |
| | bismethylenephosphonic acid | | | | |
| C | DL-1-Aminoethylphoshonic | 70.2/28/1.8 | 44.3 | 0.15 | 0.14 |
| | acid | | | | |

### Example 2

### Detection of the Phosphorus Content at Various Dilutions

Polymers A, B and C are diluted with water and the phosphorus content (in ppm) is determined by means of the ICP-AES test. The table which follows summarizes the results.

| Polymer | 1/1000 dilution | 1/5000 dilution | 1/25 000 dilution |
|---|---|---|---|
| A | 1.93 | 0.39 | 0.08 |
| B | 9.59 | 1.85 | 0.37 |
| C | 1.57 | 0.31 | 0.06 |

It is found that the phosphorus and hence the polymer can still be detected even at high dilution and thus its content can be determined.

### Example 3

### Scale Inhibition (of Barium) of Polymers A, B and C

The polymers A, B and C to be tested were pipetted into 100 ml laboratory glass bottles in a concentration of 20, 40, 60, 80 and 100 ppm and admixed with in each case 2 ml of sodium acetate buffer at pH 6.5.

A supersaturated BaSO₄ solution is then prepared in situ by adding Ba²⁺-containing formation water 1:1 with SO₄²⁻-containing seawater (in each case 50 ml, preheated to 70° C.) to the abovementioned 100 ml bottles.

Formation water and seawater have the following composition:

| | |
|---|---|
| Forties water | Formation water |

| Conc. by mass | | | Mol. conc. |
|---|---|---|---|
| in g/l | Salt | M (Salt) | in mmol/l |
| 12.95 | CaCl₂*2H₂O | 146.978 | 88.11 |
| 15.36 | MgCl₂*6H₂O | 203.224 | 75.58 |
| 2.039 | SrCl₂*6H₂O | 266.544 | 7.65 |
| 0.449 | BaCl₂*2H₂O | 244.208 | 1.84 |
| 45.00 | NaCl | 58.43 | 770.15 |

| | |
|---|---|
| Forties water | Seawater |

| Conc. by mass | | | Mol. conc. |
|---|---|---|---|
| in g/l | Salt | M (Salt) | in mmol/l |
| 1.48 | KCl | 74.54 | 19.86 |
| 3.589 | Na₂SO4 | 141.98 | 25.28 |
| 0.685 | NaHCO₃ | 83.97 | 8.16 |
| 56.3 | NaCl | 58.43 | 963.55 |

The solutions are subsequently heated in a water bath at 70° C. for 24 h and then an aliquot portion is withdrawn, filtered through a 0.45 μm filter and stabilized with a complexing agent.

To determine the Ba content of the samples by means of ICP-AES, an additional control sample is prepared. This comprises the maximum possible concentration of Ba²⁺ and is prepared by a 1:1 dilution of formation water with distilled water.

The ICP-AES results are processed as follows:

Example Calculation:

$$Inhibiting action of polymer 1 ( 20 ppm ) [ \% ] = \frac{{c}_{{Ba}^{2 +}} ( Polymer 1 , 20 ppm ) * 100}{{c}_{{Ba}^{2 +}} ( Control )}$$

c_{Ba}_{²⁺}(Polymer1, 20 ppm)=mean (in mg/l) of a threefold termination with use of 20 ppm of polymer 1.

c_{Ba}_{²⁺}(Control)=mean (in mg/l) from the threefold determination of the control sample.

The table which follows shows the results obtained.

| | Ba²⁺ content [in mg/l] | | | | |
|---|---|---|---|---|---|
| ppm | 1^{st} | | | | Inhibiting |
| Without | measure- | 2^{nd} | 3^{rd} | | action |
| polymer | ment | measurement | measurement | Mean | in % |
| Blank value | 0.1 | 0.1 | 0.1 | 0.1 | 0 |
| Control | 64.4 | 63.2 | 63.7 | 63.8 | 100 |
| Polymer B | | | | | |
| 20 | 58.3 | 58.0 | 57.5 | 57.9 | 91 |
| 40 | 59.1 | 59.1 | 59.2 | 59.1 | 93 |
| 60 | 59.5 | 60.2 | 59.1 | 59.6 | 93 |
| 80 | 60.9 | 60.8 | 60.5 | 60.7 | 95 |
| 100 | 61.3 | 61.2 | 60.8 | 61.1 | 96 |
| Polymer A | | | | | |
| 20 | 61.8 | 62.6 | 62.5 | 62.3 | 98 |
| 40 | 61.6 | 63.5 | 61.5 | 62.2 | 98 |
| 60 | 62.1 | 61.5 | 61.9 | 61.8 | 97 |
| 80 | 61.2 | 62.2 | 61.9 | 61.8 | 97 |
| 100 | 62.3 | 64.4 | 64.0 | 63.6 | 100 |

It is found that polymers A, B and C exhibit excellent inhibiting action.

1. A process for preparing a phosphorus-containing polymer, comprising the steps of
(i) copolymerizing at least
(a) monoethylenically unsaturated dicarboxylic anhydrides having from 4 to 6 carbon atoms with
(b) olefins of the formula CH₂═C(R¹)R² where
R¹ is H or CH₃ and
R² is H, CH₃, C₂H₅ or phenyl;
(ii) reacting the polymer formed in step (i) with at least one primary or secondary phosphorus-containing amine or a phosphorus-containing alcohol and
(iii) at least partly ring-opening the remaining anhydride groups.

2. The process according to claim 1, wherein the olefin is isobutene and the anhydride is maleic anhydride.

3. The process according to claim 1, wherein the molar ratio of anhydride to olefin is in the range from 20:1 to 1:5.

4. The process according to claim 1, wherein the mean molar mass M_{w} of the polymer before the at least partial ring-opening of the anhydride groups is in the range from 200 to 10 000 g/mol.

5. The process according to claim 1, wherein the amount of amine or alcohol is from 0.01 to 30% by weight based on the polymer formed in step (i).

6. A phosphorus-containing polymer obtainable from the process according to claim 1.

7. A process for preventing Ba/Sr scale, comprising the step of
(a) adding a phosphorus-containing polymer according to claim 6 to a liquid which is suitable for depositing Ba/Sr scale in a liquid environment.

8. The process according to claim 7, wherein the phosphorus-containing polymer is added as a salt in an aqueous solution.

9. The process according to claim 7, wherein the liquid comprises water and/or mineral oil and/or natural gas.

10. The process according to claim 7, wherein the liquid environment serves to store, heat or cool, transport or deliver the liquid, or as a deposit of the liquid.

11. The process according to claim 10, wherein the liquid environment is a tank, a pipeline, a pressure vessel, a rock formation, or a production and/or injection borehole for mineral oil or natural gas extraction, or storage tanks or apparatus in oil production.

12. The process according to claim 7, wherein the phosphorus-containing polymer is added in such a way that it has a concentration in the liquid of at most 250 ppm (based on the weight of the polymer and of the liquid).

13. The process according to claim 7, wherein the liquid environment is a borehole and the phosphorus-containing polymer is metered in at the lower end of the borehole.

14. The process according to claim 7, wherein the liquid environment is a rock formation and the phosphorus-containing polymer is pressed into the formation together with the injection water.

15. The process according to claim 7, wherein the phosphorus-containing polymer is pressed into a rock formation through a production borehole (squeeze treatment).

16. The process according to claim 7, comprising the further steps of
(b) withdrawing a sample from the liquid environment, comprising the phosphorus-containing polymer, and
(c) determining the phosphorus content of the sample, if appropriate after derivatizing the phosphorus-containing polymer.

17. The process according to claim 16, wherein the derivatization comprises an oxidation of the phosphorus in the phosphorus-containing polymer and if appropriate a hydrolysis.

18. The process according to claim 16, wherein the phosphorus content is determined with the aid of a molybdenum blue test or of inductively coupled plasma atomic emission spectrometry.

19. The process according to claim 2, wherein the molar ratio of anhydride to olefin is in the range from 20:1 to 1:5.

20. The process according to claim 2, wherein the mean molar mass M_{w} of the polymer before the at least partial ring-opening of the anhydride groups is in the range from 200 to 10 000 g/mol.
